(19) United States
(12) Patent Application Publication
(10) Pub. No.: US 2011/0256287 A1
(43) Pub. Date: Oct. 20, 2011

(54) Steam injection cooking device and method

(76) Inventors: Gerald A. Sus, Frankfort, IL (US); Henry T. Ewald, Roselle, IL (US); Paul G. Simmons, Glen Ellyn, IL (US)

(21) Appl. No.: 12/798,937

(22) Filed: Apr. 14, 2010

(51) Int. Cl. A47J 27/04; A23L 1/00; A47J 36/00

(52) U.S. Cl. 426/510; 99/330; 99/473

(57) ABSTRACT

An apparatus and method are provided for steam injection heating of a food product contained in the interior of a container. The apparatus includes a steam generator for generating steam and a steam exit port that is in fluid communication with the steam generator. Steam is injected though the exit port into the container. The apparatus has a surface for permitting the container interior to be put into an at least substantially sealed condition in a substantially closed environment with the exit port in fluid combination with the interior of the container. A container support supports the container and in combination with the sealing surface causes the container to be placed in the at least substantially sealed position.

### FIELD OF THE INVENTION

This invention relates to a steam injection device for cooking and/or heating food and method for cooking and/or heating food in a container.

### BACKGROUND OF THE INVENTION

This invention generally relates to a method and apparatus for high speed injection steam heating and/or cooking of a containerized batch of food product. The apparatus and method are particularly useful in heating food in quantities typically used in filling orders in a Quick Service Restaurant (QSR).

The types of food heated by steam injection include a variety of food products ranging from scrambled eggs, rice, noodles, pasta, stew and soup, for example. Scrambled eggs have been commonly cooked in small batches in a frying pan or on a grill. Attempts that have been made to cook scrambled eggs by steam heating have generally been used to cook larger batches of eggs in a continuous production process, rather than a smaller amount, such as for filling an individual serving scrambled egg order, or a few orders, such as is advantageous for QSR operations.

U.S. Pat. No. 4,228,193 to Schindler discloses a method and apparatus for cooking smaller batches of uncooked shelled eggs to form scrambled eggs using compressed air in combination with steam. The apparatus includes an air compressor, compressed air tank, and a steam generator that makes the apparatus relatively bulky. The device is not easily portable or suitable for countertop use.

A need exists for a method for rapidly cooking by steam injection of food products, such as, scrambled eggs, rice, noodles, pasta, stew and soup that is safe, efficient, and relatively easily controlled.

A need also exists for relatively rapidly cooking and/or heating food products, such as, scrambled eggs, rice, noodles, pasta, stew and soup in various size batches that are typical order sizes experienced for a QSR.

A need further exists for rapidly heating to a predetermined temperature different types of bulk food products, in smaller amounts such as one or more serving sizes.

A still further need exists for a device for heating a bulk food product that is safe, efficient, portable and self contained, so that the device is suitable for placement and use in a home kitchen, office, or other such locations.

### SUMMARY OF THE INVENTION

In accordance with one aspect of the present invention an apparatus for heating food contained in the interior of a container is provided. The apparatus comprises a steam generator for generating steam. A steam exit port is in fluid communication with the steam generator. Steam is injected through the exit port and into the container. A sealing surface permits the container interior to be put into an at least substantially sealed condition in a substantially closed environment with the exit port being in fluid communication with the interior of the container. A container support supports the container and in combination with the sealing surface causes the container to be placed into the at least substantially sealed position. As used herein, “heating” includes “cooking” with respect to food.

In accordance with another aspect of the present invention the apparatus has a first relative position for the sealing surface and the container support whereat the container can be positioned on the support, and a second relative position of the sealing surface and the container support whereat the support in combination with the sealing surface causes the container to be placed into the at least substantially sealed position for the injection of steam into the container. A motor is provided for causing movement between the first relative position and the second relative position of the sealing surface and the container support.

In accordance with a further aspect of the invention the motor applies a force to the support while at the sealing position to thereby maintain the sealing of the container.

In accordance with another aspect of the invention the support is transported toward a stationary sealing surface to cause the container to be placed into the at least substantially sealed position.

In accordance with still another aspect of the present invention the sealing surface is transported toward a stationary support to cause the container to be placed into the at least substantially sealed position.

In accordance with a further aspect of the present invention the support includes a locator for aligning the container with the exit port and the locator also provides alignment with the sealing surface to allow the container interior to be placed in the substantially sealed position when at the second relative position.

In accordance with another aspect of the present invention the apparatus includes a control for initiating steam injection into the container and a sensor for sensing if the container is in the at least substantially sealed position. If not, steam injection is not initiated. During steam injection, the control terminates steam injection if the sensor senses that the container interior is no longer in the substantially sealed position.

In accordance with a further aspect of the present invention the motor of the apparatus applies a force to maintain the container in the substantially sealed position during the injection of steam into the interior of the container.

In accordance with another embodiment of the present invention the apparatus includes a carrier for holding the container and supporting the container during the injection of steam into the container.

In accordance with another embodiment of the present invention the apparatus includes a wand with an exit port for steam injection heating of food contained in a container. The apparatus has a sealing surface and a mating surface that are relatively moveable between a first position for positioning the container on a support, and a second position for placing the interior of the container in an at least substantially sealed position. The container has an opening and rim adjacent to the opening with the rim having an inner diameter. The apparatus includes a locator on the support for aligning the container. The locator has a placement area with an outer border having a radius Rp that is selected from a range having a low end of approximately 10% greater than the outer radius of the bottom of the container and a high end that is slightly less than Ri−Rw+Rb; where Ri is the radius at the inner edge of the rim of the container, Rw is the outer radius of the wand, and Rb is the radius at the outer edge of the bottom of the container, so that when the bottom of the container is entirely positioned within the border of the placement area and the apparatus is moved from the first relative position to the second relative position, the wand enters the opening and is not contacted by the container, and the mating surface contacts the target area of the sealing surface to cause the container to be placed in the substantially sealed position.

In accordance with another aspect of the present invention the apparatus includes a wand with an exit port for steam injection heating of food contained in a container. The apparatus has a sealing surface and a mating surface that are relatively movable between a first position for positioning the container on a support, and a second position for placing the interior of the container in an at least substantially sealed position. The container has an opening and rim adjacent to the opening with the rim having an inner diameter. The apparatus includes a carrier for supporting a container for steam injection heating of its contents, and has a locator for aligning the carrier on the support. The locator has a placement area with an outer border that has a radius Rp that is selected from a range having a low end of approximately 10% greater than the outer radius Rc of the bottom of the carrier and a high end that is slightly less than Ri−Rw+Rc; where Ri is the radius at the inner edge of the rim of the container, Rw is the radius of the wand, and Rc is the radius at the outer edge of the bottom of the carrier, so that when the bottom of the carrier is entirely positioned within the border of the placement area and the apparatus is moved from the first relative position to the second relative position, the wand enters the opening of the rim and is not contacted by the container, and the mating surface contacts the target area of the sealing surface to cause the container to be placed in the substantially sealed position.

In accordance with another embodiment of the present invention a method of heating food contained in the interior of the container is provided. The method comprises providing a steam generator for generating steam, and an exit port in fluid communication with the steam generator for injecting steam therethrough into the container. A sealing surface is also provided for permitting the container interior to be put in an at least substantially sealed condition in a substantially closed environment with the exit port in fluid communication with the interior of the container. A support for supporting the container is additionally provided. The container is supported on the support. Relative movement between the support and the sealing surface is conducted to cause the container interior to be placed in an at least substantially sealed position with the exit port in fluid communication with the interior of the container. Thereafter steam is injected into the interior of the container to heat the food in the container.

Other advantages and features of the invention will become apparent from the following description and from reference to the drawings.

### BRIEF DESCRIPTION OF THE DRAWINGS

FIG. 1 is a perspective view of the apparatus in accordance with the present invention;

FIG. 2 is a front elevation view of the apparatus shown in FIG. 1;

FIG. 3 is a schematic view of the apparatus of the present invention;

FIG. 4 is a side elevation view of the apparatus in accordance with the present invention;

FIG. 5 is a cross-sectional view of the apparatus of FIG. 1 showing the platform and container moved to the sealing position;

FIG. 6 is an enlarge partial cross-sectional view of the apparatus shown in FIG. 5 illustrating a sealed container;

FIG. 7 is a cross-sectional view of a second embodiment of the apparatus in accordance with present invention;

FIG. 8 is an enlarged partial cross-sectional view of the apparatus shown in FIG. 7 illustrating a sealed container positioned in a carrier;

FIG. 9 is an enlarged partial cross-sectional view of the apparatus shown in FIG. 5 illustrating the container sealed by a modified gasket;

FIG. 10 is an enlarged partial cross-sectional view of the apparatus shown in FIG. 6 illustrating the container and carrier sealed by a modified gasket;

FIG. 11 is a partial view of a third embodiment of the apparatus in accordance with the present invention;

FIG. 12 is a partial view of a third embodiment of the apparatus in accordance with the present invention illustrating the platform of the apparatus; and

FIG. 13 is a partial cross-sectional view of a fourth embodiment of the apparatus in accordance with the present invention.

### DETAILED DESCRIPTION

While this invention is susceptible of embodiment in many different forms, there are shown in the drawings and described in detail herein, several specific embodiments with the understanding that the present disclosure is to be considered as exemplifications of the principles of the invention and is not intended to limit the invention to the embodiments illustrated.

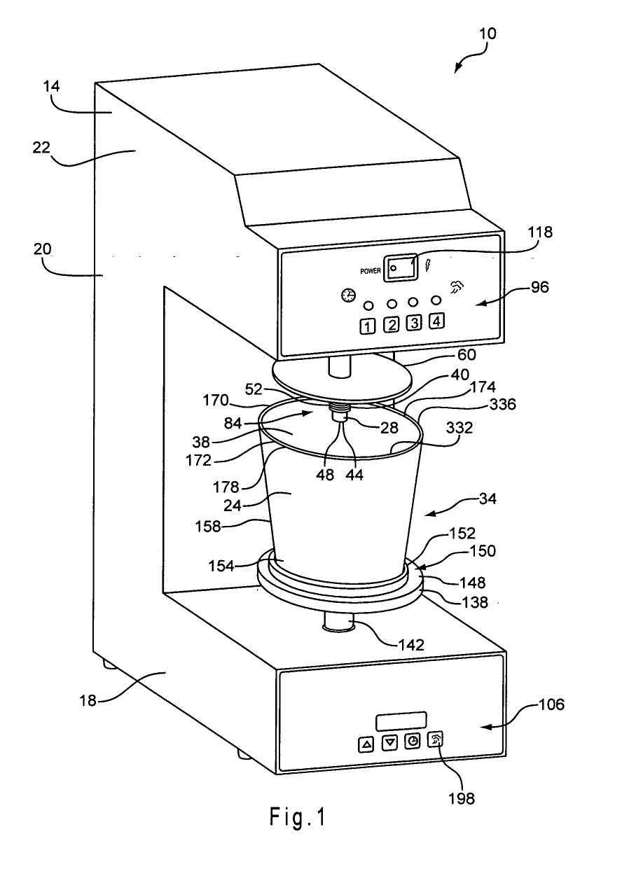

Referring to the FIGS. 1-6, an apparatus 10 for heating a food product 12 by steam injection is illustrated. The present invention provides an efficient low power usage method and apparatus for steam injection heating relatively smaller amounts of bulk food product wherein most of the energy consumed is put into heating the food. In some instances, the heating of food product 12 may be for the purposes of cooking food product 12. In other instances, the heating may be merely to heat a previously cooked food product 12. Food product 12 may be an unmeasured quantity of food, or at other times be a predetermined quantity of food, such as one or more servings of the food product 12. Examples of food products that may be heated by apparatus 10 include scrambled eggs, rice, noodles, pasta, stew, soup as well as other types of food.

Apparatus 10 includes a housing 14 with a base 18, a neck 20 and an upper housing portion 22. An amount of food product 12 to be heated by apparatus 10 is placed in a cup or container 24. As described later in greater detail, food product 12 is heated by steam that is injected into the food through a wand 28. The steam for injection heating is generated by a flash steamer 30. Any flash steamer 30 can be used in accordance with the invention. Typically, a flash steamer will be comprised of a cavity 32 having a heated surface into which water is injected to rapidly form steam in the heated cavity.

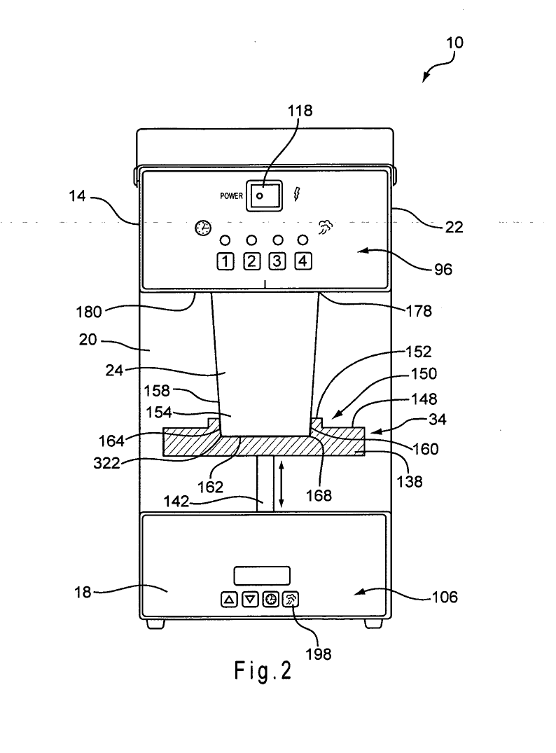

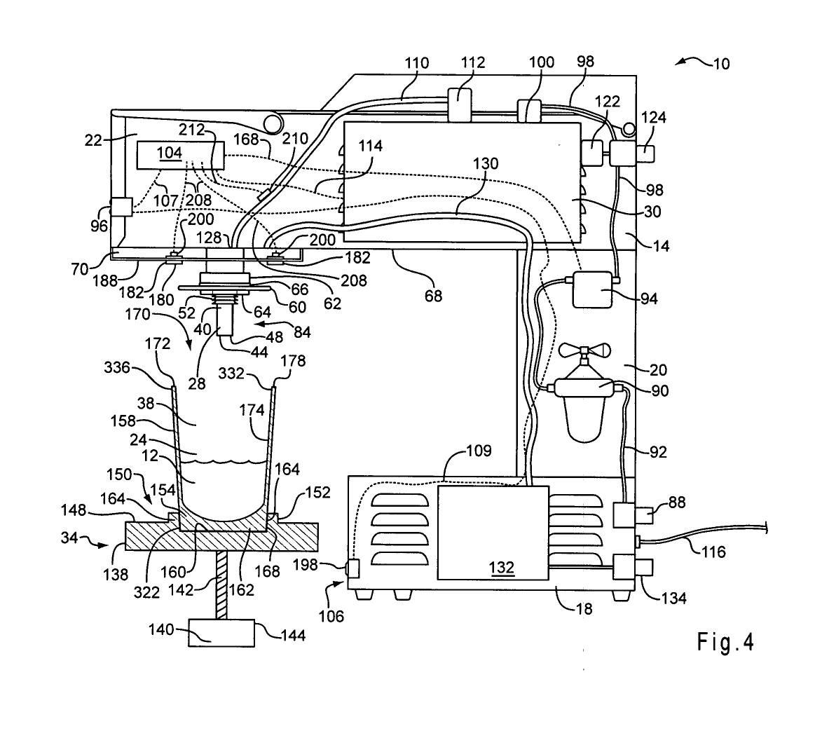

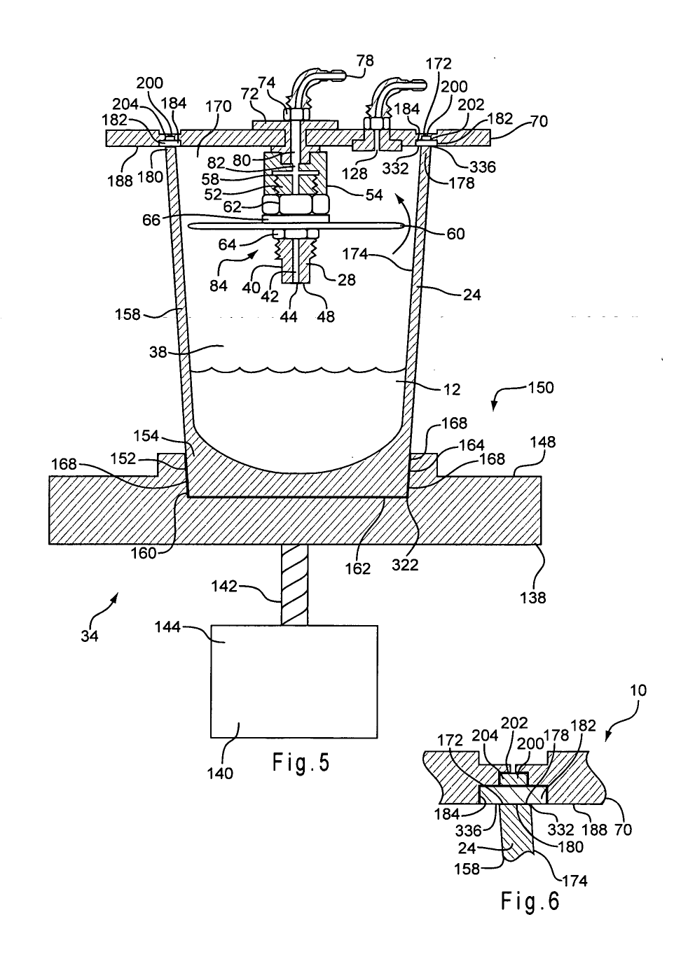

Apparatus 10 includes a container transport system 34 that is used to reciprocally transport container 24 between a loading position and a sealing position. At the loading position, as seen in FIGS. 1 and 4, a clearance is provided between wand 28 and container 24 to allow convenient loading and unloading of container 24. When container transport system 34 has been moved to the sealing position seen in FIGS. 2 and 5, the interior 38 of container 24 is sealed for the steam injection heating of contained food product 12. Container transport system 34 of the present invention is adaptable for use with various types of steam injection heating devices used for heating food as known to those skilled in the art. U.S. Pat. No. 4,233,891 and U.S. patent application Ser. Nos. 12/080,850 and 12/658,519 provide more detailed descriptions of steam injection heating devices and their specifications are expressly incorporated herein in the entirety by reference.

In the exemplary steam injection heating apparatus 10 utilizing container transport system 34 of the present invention, wand 28 has a generally cylindrical body 40 having an axially centered steam passageway 42 extending therethrough. Passageway 42 has a steam injection exit port 44 that preferably is located at a bottom terminal end 48 of wand 28. Terminal end 48 of exemplary wand 28 is positioned above the intended level of food product 12 as it is contained in a sealed cup 24 prior to heating. In other instances, wand 28 may be of an extended length so that its terminable end is immersed in food product 12. Typically, passage 42 will have a single steam exit port 44 that preferably directs exiting steam directly downward toward food product 12 to thereby maximize the agitation and mixing of food product 12. Wand 28 has a threaded upper portion 52 for mounting a quick release connector 54 at top end 58 of wand 28. Also positioned on wand upper portion 52 is a disc-shaped baffle 60 that is secured in place by nuts 62, 64 and washer 66. Baffle 60 is optionally provided to minimize the splattering of bulk food product 12 held in cup 24 as it is injected with steam through wand 28. During steam injection heating, baffle 60 redirects upwardly splattering food product 12 downward back into the mass of food product 12.

The upper housing portion 22 has a lower surface 68 to which a plate 70 is secured. Mounted to plate 70 is a quick release connector 72 for cooperation with quick release connector 54 on wand 28. Quick release connector 72 is secured in place by a nut 74, and has an inlet end 78 for connection to a source of injected steam from flash steamer 30. Quick release connector 72 has an outlet end 80 that is inserted into the inlet end 82 of connector 54 to couple together quick release connectors 72 and 54. Typically, the wand assembly 84, which includes wand 28, wand quick release connector 54 and baffle 60, remains mounted to apparatus 10 except when removed for cleaning.

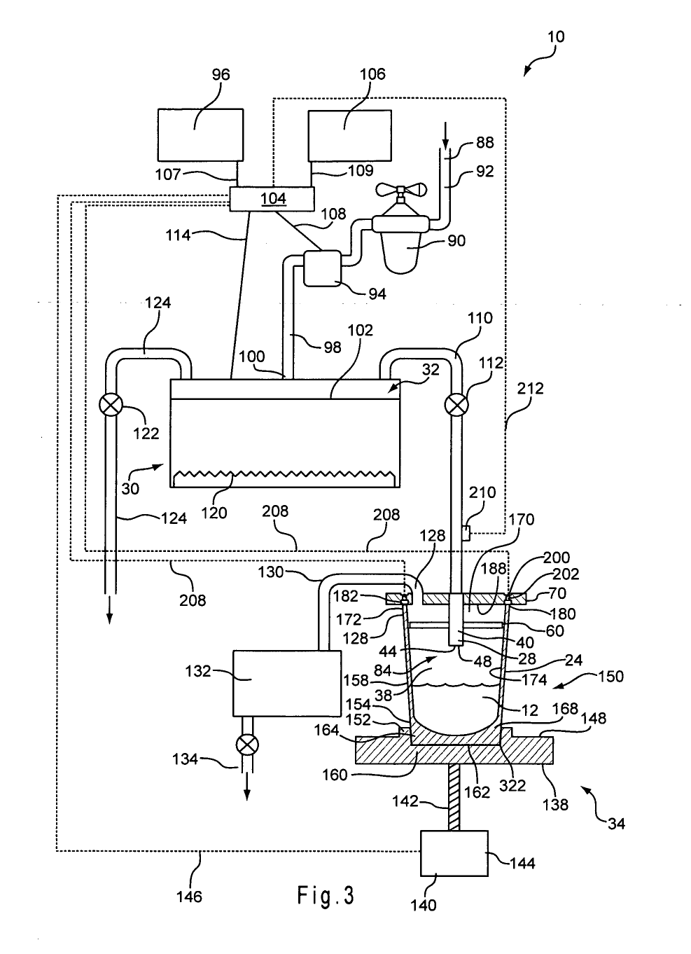

FIG. 4 is a schematic illustration of the system of apparatus 10. Apparatus 10 includes a water inlet line 88 that is connected to a source of water, such as for example, a water line of the Quick Service Restaurant in which apparatus 10 may be used. Optionally apparatus 10 may be modified to have a self-contained supply of water, such as by including a water storage tank (not shown). A water pressure regulator 90 is provided along conduit 92 to maintain inlet water pressure for apparatus 10 at a desired level for flash steamer 30, which typically will be in the range of about 20 psi to about 60 psi. A liquid water injector, such as a solenoid valve 94, is openable to allow water to flow from water inlet line 88 through solenoid valve 94 to water conduit 98 for injection into flash steamer 30. Flash steamer 30 has an inlet 100 to receive a quantity of liquid water injected into flash steamer 30. The injected water is directed against a heated cavity surface 102 in the heated cavity 32 of flash steamer device 30, as shown in FIG. 3, to cause rapid conversion into steam of substantially all of the injected quantity of water.

In a typical operation of apparatus 10, solenoid valve 94 opens momentarily to cause a pulse of a quantity of water, which may be a predetermined quantity of water, to be injected into flash steamer 30. To accomplish this, a control 104 is connected to solenoid valve 94 by cable 108. Control 104 provides a signal to cause solenoid valve 94 to open for a relatively short period of time, and then cause solenoid valve 94 to return to its normally closed position after the quantity of water has been injected. Control 104 includes a micro-processor controller having suitable software and electronically stored programmed data necessary to provide injected water pulses for various modes of heating, as well as for controlling other functions of apparatus 10. The desired mode of heating is selected by the operator's use of input selection buttons 96 and 106, that communicate with control 104 via cables 107 and 109, respectively. In one selected mode of heating, the amount of the injected pulse of water may be of a predetermined amount that when converted to steam is sufficient for cooking a predetermined amount of food product 12 contained in container 24. In other instances, the amount of injected water pulse, when converted to steam, may be an amount that incrementally raises the temperature of food product 12. An example of this is when multiple pulses of water are injected into food product 12 to incrementally heat food product 12 to a pre-selected temperature.

In either instance, the steam produced at flash steamer 30 exits flash steamer 30 through conduit 110. A one way check valve 112 is preferably included to prevent the steam from flowing back towards flash steamer 30. The supply of steam travels through conduit 110 and enters passageway 42 of wand 28. Thereafter, the steam travels to wand 28 and out exit port 44 to be injected into food product 12 to cause injection heating. Typically, the steam traveling through wand 28 is of a sufficient velocity to cause mixing of bulk food product 12 in container 24.

In addition to controlling the injection of water into flash steamer 30, control 104 also may control and monitor the operation of flash steamer 30. Connected to flash steamer 30 by cable 114, control 104 may be programmed to control the preheating of heated surface 102, maintain heated surface 102 at a predetermined temperature, and otherwise monitor the operation of flash steamer 30 and apparatus 10. Typically, the temperature of heated surface 102 will be maintained at about 400° F. by control 104 powering on and off the exemplary heating means of an electrical heating element 120. The typical temperature of the steam generated by flash steamer 30 is about 230° F. or more. Apparatus 10 is connected to a power source through power cord 116, and turned on and off at power switch 118.

A pressure relief valve 122 may be provided for flash steamer 30 to prevent excessive build up within heated cavity 32 of flash steamer 30. Pressure relief valve 122 typically opens to vent cavity 32 whenever the pressure in cavity 32 exceeds a pre-selected pressure amount, for example about 15 psig, or lower. Vented steam is released through a blow-off conduit 124 that directs the vented steam to a safe location away from the operator of apparatus 10. Any excess steam that is not used for cooking food product 12 is vented from container interior 38 at an outlet vent 128 through conduit 130 leading to a condenser 132. At condenser 132, the excess steam is condensed into liquid water that drains at a drain 134.

Having described an exemplary basic steam injection heating operation of apparatus 10, a more detailed description of the operation of container transport system 34 is now provided. Container transport system 34 includes a platform 138 and a motor 140 that is operated to reciprocally move platform 138 between the loading position shown both in FIGS. 1 and 4, to the sealing position shown both in FIGS. 2 and 5. A shaft 142 operably connects platform 138 to motor 140. Motor 140 is operated to extend shaft 142 upward from motor housing 144 to cause platform 138 to be moved upward to the sealing position. Motor 140 can also be operated to cause shaft 142 to be retracted downward toward motor housing 144 to thereby move platform 138 downward to the loading position. Motor 140 may be an electric motor, a hydraulic motor or any other type motor suitable for reciprocally moving platform 138 between the loading position and sealing position. Transport system 34 preferably is automatically controlled by control 104 that communicates with motor 140 via cable 146. Control 104 automatically operates motor 140 to thereby cause the movement of platform 138. As shown in FIGS. 3 and 4, control 104 also controls other functions of the steam injection heating processes of apparatus 10. Alternatively, a separate control may be dedicated to only controlling motor 140 for causing the movement of platform 138.

Referring to FIG. 1, in the loading position platform 138 is sufficiently spaced from wand 28 to provide adequate clearance for the placement of container 24 onto platform 138. The top surface 148 of platform 138 includes a container locator 150. Container locator 150 aligns container 24 on platform 138 for the unobstructed upward transport of container 24 into the sealing position where the steam injection heating of food product 12 takes place. Container locator 150 includes an annular shoulder 152 that protrudes upwardly from platform top surface 148. Annular shoulder 152 receives and abuts against the lower portion 154 of container sidewall 158 to removeably secure and align container 24 on platform 138. Alternatively, or additionally, container locator 150 may include a recess 160 in top surface 148 for receiving the bottom end 162 of container 24. In instances where container 24 has a slanted sidewall 158, shoulder 152 and recess 160 may also have slanted surfaces 164 and 168, respectively, that conform to the slanted surfaces of lower portion 154 of the container sidewall 158.

When container 24 has been positioned in locator 150, the open top 170 of container 24 and the top surface 172 of container 24 are properly aligned for the upward movement of platform 138 from the loading position to the sealing position. More specifically, container 24 is aligned relative to downwardly depending wand 28 and optional baffle 60. Such alignment allows wand 28 and baffle 60 to enter container interior 38 without obstruction, and remain spaced way from the inner side 174 of sidewall 158 during the upward travel of platform 138. The rim 178 of container 24 is additionally aligned for the targeted upward movement to a sealing surface 180. As platform 138 moves into the sealing position, container rim 178 contacts sealing surface 180 to thereby seal container interior 38. As best illustrated in FIG. 6, in one preferred embodiment of apparatus 10, sealing surface 180 is located on plate 70 secured to lower surface 68 of upper housing portion 22. Optionally, sealing surface 180 can be located directly on lower surface 68 of upper housing portion 22, rather than on separate plate 70. Sealing surface 180 preferably includes a gasket 182. Gasket 182 may be mounted in an annular recess 184 in lower surface 188 of plate 70. Optionally, as seen in FIG. 9, gasket 182 may be replaced with a modified gasket 186 that includes an annular groove 190 to provide an enhanced sealing engagement with the surfaces of the top portion 192 of container sidewall 158, in addition to sealing at the top surface 194 of rim 178.

After platform 138 comes to a stop at the sealing position, motor 140 preferably continues to apply an upward force to platform 138. The continued application of an upward force ensures that the seal between rim 178 and gasket 182, or modified gasket 186 when applicable, will not be broken by the forces arising during steam injection heating. To accomplish this, the amount of continued upward force applied by motor 140 preferably is at least that which is sufficient to counteract the anticipated downward force on container 24 that will be generated by the pressure of the steam entering container 24 during steam injection heating.

The automatic controlling of transport system 34 may be more clearly understood by describing in greater detail the steps that occur in one typical mode of operation of apparatus 10 to heat food product 12. To begin the process, a desired amount of food product 12 to be heated is placed in container 24. With platform 138 at the loading position, container 24 is then manually placed on platform 138 and aligned thereon by locator 150. The operator uses input buttons 106 to select a desired temperature to which food product 12 is to be heated. The operator then initiates steam injection heating by pushing a “start heating” button 198. Control 104 then sends a signal to motor 140 to begin movement of platform 138 along an upward path to the sealing position. The upward movement of platform 138 transports container rim 178 into sealing contact with gasket 182, as can be seen in FIGS. 2, 5 and 6. With interior 38 of the container 24 sealed, apparatus 10 is now ready to automatically conduct the selected mode of steam injection heating of the contained food product 12. To automatically prevent steam injection from being initiated if container 24 is not properly sealed, apparatus 10 may also include one or more pressure sensing or force sensing devices 200. As best seen in FIGS. 5 and 6, pressure sensor 200 is positioned above gasket 182. Sensor 200 is mounted within an opening 202 in plate 70 and wedged in place between gasket 182 and a ledge 204 in opening 202.

Sensor 200 senses the amount of force that rim 178 exerts against gasket 182 and sends the sensed information to control 104 through a cable 208. Once a predetermined minimum amount of force is sensed at force sensor 200, container 24 is presumed to be properly sealed at gasket 182. Thereafter, and only thereafter, does control 104 allow the initiation of steam generation and steam injection through wand 28. Control 104 may also be programmed to terminate steam injection if, at any time during the steam injection heating process, the force sensed by force sensor 200 drops below a predetermined amount force. Such predetermined amount of force would be an amount that is at least slightly higher than the minimum amount of force that is required for rim 178 to press against gasket 182 to provide adequate sealing of container 24 for injection steam heating purposes. This predetermined amount may be, for example, the same predetermined amount of force that is selected as the minimum required force to be sensed at sensor 200 to allow the steam injection heating process to be initiated, or some other lower amount of force.

Control 104 preferably is also programmed to automatically cause motor 140 to lower platform 138 downward away from the sealing position after the steam injection heating of the food has been completed. Typically, platform 138 is lowered to the initial loading position where container 24 and heated food product 12 may be conveniently removed from platform 138. Apparatus 10 may also include means to ensure that platform 138 will not be lowered away from the sealing position until the pressure within container 24 has been reduced to a pre-selected acceptable level. To accomplish this, apparatus 10 includes a pressure sensor 210 for sensing the pressure within interior 38 of container 24. The sensed pressure information is sent via cable 212 to control 104. Pressure sensor 210, as shown in FIG. 4, may be remotely located from container interior 38, such as along conduit 110 that is connected to wand 28. Since conduit 110 is fluidly connected to container interior 38, sensing pressure in conduit 110 will indicate the pressure level within container interior 38. When the pressure within container interior 38 has been sensed to have returned to an acceptable level, for example about atmospheric pressure, control 104 will then allow motor 140 to operate to cause the lowering of platform 138 away from the sealing position. Waiting until pressure in interior 38 is reduced eliminates the possibility of food splattering out of container 24 when it is lowered away from gasket 182. It also allows for a more quiet operation of apparatus 10 by reducing or eliminating a noise that otherwise might occur upon a separation of a pressurized container 24 and gasket 182.

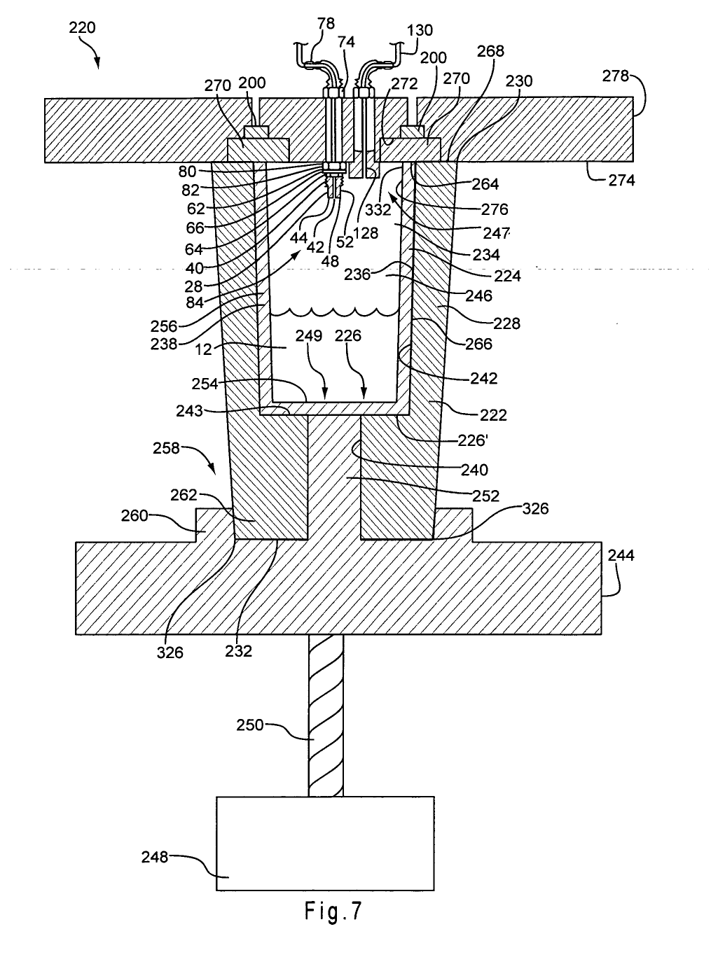

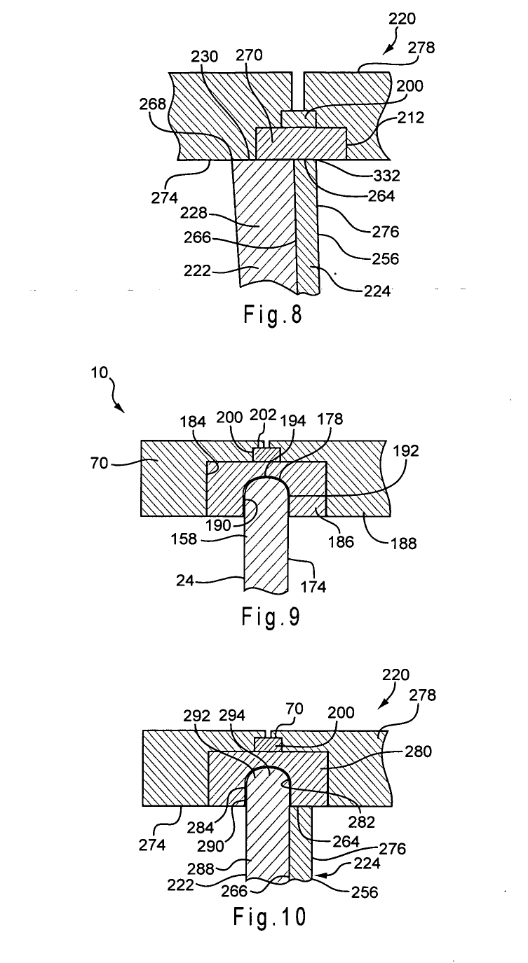

A second embodiment of the present invention is shown in FIGS. 7 and 8 as apparatus 220. Apparatus 220 has a carrier 222 for holding and supporting a container 224 during transport and steam injection heating. In this embodiment the container used may be a one time use container, such as container 224, rather than a reusable container, such as container 24. Carrier 222 has a generally cylindrical shaped body 228 with a top end 230 and a bottom end 232. An opening 234 in top end 230 leads to an interior well 238 within carrier 222. Well 238 is defined by inner surfaces 236 of the carrier 222, including the well sidewall surfaces 242 and the well bottom surface 243. Opening 234 and interior surfaces 236 of interior well 238 are sized and configured for the reception and support of container 224. Carrier 222 may also include a container removal access opening 240. Access opening 240 extends from bottom end 232 of carrier 222 to bottom well surface 243. Access opening 240 may be used to easily separate container 224 from carrier 222. To do so, the user inserts a finger into access opening 240 and pushes against container bottom end 226.

In operation, food product 12 to be steam injection heated is placed in container interior 246 through the top opening 247 of container 224. Container 224 is inserted through carrier top opening 234 into carrier well 238. Alternatively, food product 12 may be placed into container 224 when container 224 has already been placed within carrier 222. The assembled carrier 222 and container 224 are removeably placed on a platform 244. Platform 244, like platform 138 of the first embodiment, is reciprocally movable between a loading positioning and a sealing position by a motor 248. A shaft 250 connects motor 248 to platform 244. Platform 244 may have a configuration that is generally similar to platform 138 of apparatus 10, except that platform 244 may also include a stem 252 that extends upwardly into container access opening 240 of a mounted carrier 222. The top 254 of stem 252 abuts and supports the central portion 249 of bottom end 226 of container 224. Thus, the entire bottom end 226 of a mounted container 224 is supported by well bottom surface 243 and stem top 254. Platform 244 also may include a carrier locator 258 that functions in similar manner as container locator 150 of apparatus 10. Carrier locator 258 aligns carrier 222, and container 224 carried by carrier 222, on platform 244 for unobstructed transportation to the sealing position. Carrier locator 258 may include an annular rim 260 that cooperates with stem 252 to support and align the lower portion 262 of carrier 222.

As best seen in FIG. 8, when at the sealing position, the rim 264 of container 224 and the rim 268 of carrier 222 are both sealingly engaged by, and mate with, a gasket 270. Gasket 270 is secured in an annular recess 272 in the lower surface 274 of a plate 278. Plate 278, like plate 70 of apparatus 10, is secured to lower surface 68 of apparatus upper housing 22. Optionally, gasket 270 can be positioned to sealingly engage only container rim 264, or only carrier rim 268. Apparatus 220 also may include one or more pressure sensors 200. In like manner to that previously described, pressure sensors 200 are used for sensing whether the sealing force at gasket 270 is sufficient to provide adequate sealing for steam injection heating. If sufficient sealing is not sensed, control 104 does not allow the initiation of steam injection heating. Once initiated, if the sensed sealing force drops below a predetermined amount, control 104 preferably is programmed to shut down a steam injection heating cycle that is in progress.

FIG. 10 shows apparatus 220 having a modified gasket 280 that includes an annular groove 282. As platform 244 transports carrier 222 upward to the sealing position, groove 282 sealingly receives carrier rim 268 and the adjacent surfaces 284 of the carrier sidewall 288. Unlike carrier sidewall 288 as shown in FIG. 8, FIG. 10 illustrates a modified carrier sidewall 290 that extends upwardly past rim 264 of container 224. Also, the top portion 292 of rim 294 of modified sidewall 286 has a configuration that corresponds to the profile of groove 282 with which rim 294 sealingly mates.

In contrast to the unsupported container 24 of apparatus 10, container 224 need not be capable of independently withstanding the force of steam injection heating. It is noted that all of the outer surfaces of container 224 are supported by carrier 222 during the steam injection heating process. Specifically, the outer surfaces 266 of container sidewall 256 and the outer surfaces 226′ of container bottom end 226 are supported by the surfaces 236 that define carrier well 238. The top 254 of stem 252 additionally supports container bottom 226. Thus, even a relatively thin and less sturdy, or flexible, container 224 can be sufficiently supported by carrier 222 for the prevention of distortion or damage to container 224 during steam injection heating. Container 224 therefore may have a bottom 226 and sidewalls 256 that are relatively thin and/or may be formed of relatively inexpensive materials, such as for example, paper, expanded foam or plastic. A low cost container 224 allows container 224 to be used as a single use and disposable container. Thus, disposable container 224 can be used for both the heating and as the packaging for food product 12, such as for example, a heated food product that is included as part of a take away meal order.

The use of the combination of container 224 and carrier 222 also reduces labor costs. This is because after heating, food product 12 does not have to be transferred from container 224 into another container for serving to a customer. Labor costs associate with cleanup are also reduced. Since container 224 is disposable, it does not require cleaning. Additionally, carrier 222 typically will not require cleaning after each use. This is because container 224 covers all of the inner well surfaces 236 of carrier 222, and thus food product 12 is not forced onto the surfaces of carrier 222 during steam injection heating.

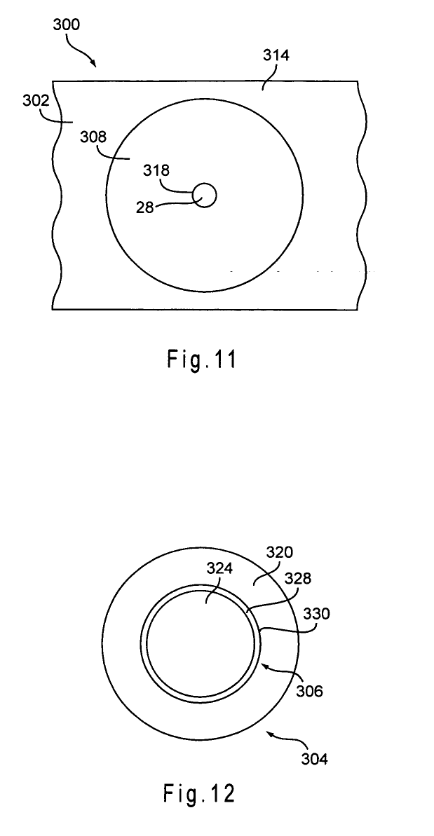

FIGS. 11 and 12 illustrate an alternative embodiment for locating and sealing elements of FIGS. 5 and 7. Upper plate apparatus 300 of FIG. 11 and platform 304 of FIG. 12 illustrate a further embodiment of the present invention for locating and sealing container 24, or carrier 222. Platform 304 has locating indicia 306 with a relatively large radius Rp compared to the radius of the bottom of container 24 or carrier 222. As explained in greater detail below, upper plate apparatus 300 and platform 304 are designed so that container 24, or carrier 222, merely can be positioned anywhere within locating indicia 306 to provide alignment for steam injection heating. Thus, container 24, or carrier 222 requires a less precise positioning with respect to locating indicia 306 and can be accomplished quickly and easily. This provides an advantage when apparatus 300 is used in fast paced operations such as that of a quick service restaurant environment. Upper plate apparatus 300 and platform 304 are similar in design and operation to plate 70 and platform 138 of apparatus 10, with plate 302 replacing plate 70, and a platform 304 replacing platform 138. Plate 302, like plate 70 of apparatus 10, may be secured to lower surface 68 of the apparatus upper housing portion 22. Plate 302 has a modified sealing surface 308 that provides a relatively large target area for receiving and sealing container 24 as it is raised by platform 304 to the sealing position. The target area provided by sealing surface 308 preferably is a large area gasket that is secured to the lower surface 314 of plate 302. Sealing surface 308 has a central opening 318 with a diameter that is large enough to allow the insertion therethrough of wand 28. Wand 28 extends downwardly from sealing surface 308. As illustrated in FIG. 11, wand 28 is shown without an attached optional baffle 60. Outlet vent opening 128 of apparatus 10 is not shown for clarity, but it is noted such venting function could be provided by other structure. For example, an outlet vent could be provided by a modified arrangement whereby venting takes place through a channel (not shown) in the outer surface of wand 28. Such an arrangement would maximize the area of sealing surface 308. In such case, sealing surface 308 thereby provides a sealing target area that extends without interruption from the outer diameter of sealing surface 308 to its inner diameter at opening 318.

By providing a relatively large target area and relatively large area locating indicia 306, a precise alignment of container 24 on platform 304 is not required. Stated another way, container 24 can be positioned in a wider range of positions on platform 304 and still be aligned for sealing engagement with sealing surface 308 to accomplish the desired sealing of container interior 38 for steam injection heating. Large target area sealing surface 308 has an outer diameter that is relatively large when compared to the inner diameter of rim 178 of container 24, preferably about 25% larger, and more preferably up to about 100% larger. The inner gasket diameter at opening 318 of sealing surface 308 is relatively small when compared to the diameter of rim 178 of container 24, preferably about 25% smaller, and more preferably, approximately about the same as the diameter of wand 28. When using carrier 222 and container 224, rather than container 24, the outer diameter of sealing surface 308 is sized relative to the diameter of the sealing surface to be upwardly transported by platform 304, for example, the diameter of rim 268 of carrier 222. In that instance, the outer diameter of sealing surface 308 is preferably about 25% larger than the diameter of the sealing surface on carrier rim 268 to be contacted, and more preferably up to about 100% larger; and the inner diameter of gasket 312 is preferably about 25% smaller than the diameter of carrier rim 268, and more preferably, approximately about the same as the diameter of wand 28.

In FIG. 12 there is illustrated exemplary platform 304 that can be used in combination with relatively large target area of sealing surface 308. Platform 304 has a top surface 320 that includes locating indicia 306 that has a placement area 324 for container 24, or carrier 222. With regard to container 24, placement area 324 has a diameter than is relatively large compared to the diameter of bottom 162 of container 24. Locator 306 may be markings or other indicia that delineate placement area 324. For example, locator 306 may be in the form of a circle 328 with an outer edge 330 that defines the outer boundaries of placement area 324. The diameter of outer edge 330 is sized so that a container 24 placed anywhere within the outer boundary of placement area 324 will be aligned for the unobstructed transport by platform 304 to the sealing position, while at the same time, will also be aligned to accomplish the sealing of rim 178 of container 24 at gasket 312 after platform 304 has been transported to the sealing position. More specifically, an aligned container 24 means that when platform 304 is moved to the sealing position, wand 28 enters container top opening 170 and remains spaced away from container sidewall 158 during transport. Additionally, when an aligned container 24 has been transported to the sealing position, rim 178 of container 24 is mated with gasket 312 to seal container interior 38 for steam injection heating.

As shown in FIG. 12, the radius Rp of the outer edge 330 that delineates the placement area 324 will vary depending on whether platform 304 is to be used to transport and align a separate container 24, or a carrier 222 that holds container 224. Radius Rp will also depend on the size and configurations of container 24, or when applicable the size and configuration of a combined container 224 and carrier 222. In any event, Rp is selected so that when the outer bottom edge 322 of container bottom 162 as shown in FIG. 5, or the outer bottom edge 326 of bottom 232 of carrier 222 as shown in FIG. 7, is placed within placement area 324, the upward travel of platform 304 to the sealing position will be accomplished: 1) without the contact of wand 28; and 2) with the contact of gasket 312 to thereby seal the interior 38 of container 24 (or when applicable, interior 246 of container 224). In greater detail, it is noted that when upper plate apparatus 300 includes an optional baffle 60, or has an outlet vent 128 that is outside the diameter of wand 28, upward movement to the sealing position will likewise be accomplished without the contact of baffle 60 or outlet vent 128 by container 24, or when applicable, container 224 and carrier 222. It is further noted that in instances where container 24 is used, the referred to sealing of container interior 38 typically is accomplished by container rim 178 being brought into sealing contact with gasket 312. In instances where carrier 222 is used, the referred to sealing of container interior 246 typically will be accomplished by gasket 312 being contacted by the upwardly transported container rim 264 and/or carrier rim 268.

It can be appreciated that the greater the placement area radius Rp, the easier it will be for a user to position a container 24 within the borders of placement area 324. Therefore, to obtain an advantage for ease of placement therein, Rp is typically at least about 10% greater than the radius of container bottom 162. If however, Rp is too great, the transport of container 24 can cause wand 28 to be contacted, or sealing surface 308 to be missed and thereby prevent the sealing of container interior 38. Thus, the high end of the range for an acceptable radius Rp is slightly less than Ri−Rw+Rb; where Ri is the radius at the inner edge 332 of rim 178 of container 24, Rw is the radius of wand 28, and Rb is the outer radius of bottom 162 of container 24. Therefore, radius Rp for locator placement area 324 for locator 306 is selected from the range having a low end of about 10% greater than Rb, and a high end of slightly less than 2Ri−Rw+(Rb−Ri). It is noted that in instances where sidewall 158 of container 24 is slanted inwardly, the value that is selected for Ri will be the smallest radius along that portion of the inner surface 174 of sidewall 158 that wand 28 must pass along during the transport of container 24 between the loading and sealing positions. Also, in instances where wand 28 has an irregular outer surface or is not cylindrical, the value that will be selected for Rw will be measured at the point that provides the largest radius Rw along that the portion of wand 28 which must travel along sidewall inner surface 174 when container 24 is transported between the loading position and the sealing position. Defining and using such values for Rw and/or Ri will insure that wand 28 does not contact sidewall 158 when container 24 is being transported between the loading and sealing positions.

In instances where a carrier 222 is used to support and carry an inner container 224, to obtain an advantage for ease of placement within the borders of placement area 324, the minimum radius Rp of placement area 324 is at least about 10% greater than the outer diameter of carrier bottom 232. The high end of the range for an acceptable radius Rp is slightly less than Ri−Rw+Rc; where Ri is the radius of at the inner edge 332 of rim 178 of container 24, Rw is the radius of wand 28, and Rc is the radius of bottom 232 of container 224. Thus, in instances where carrier 222 is used, the radius Rp of placement area 324 of locator 306 is selected from a range having a low end of about 10% greater than Rc and a high end of slightly less than Ri−Rw+Rc. It is noted that in instances where sidewall 256 of container 224 is slanted inwardly, the value that will be selected for Ri is the smallest radius along that portion of the inner surface 276 of sidewall 256 that wand 28 must pass along during the transport of container 224 between the loading and sealing positions. Also, in instances where wand 28 has an irregular outer surface or is not cylindrical, the value that will be selected for Rw will be measured at the point that provides the largest Rw along that portion of wand 28 which must travel along sidewall inner surface 276 when container 224 is transported between the loading position and the sealing position. Defining and using such values for Rw and/or Ri will insure that wand 28 does not contact sidewall 256 when container 224 is being transported between the loading and sealing positions.

It is further noted that the outer radius of gasket target area 310 is to be at least great enough to allow the receipt of, and complete mating with, the transported mating sealing surface that is transported to gasket 312 when platform 304 is moved to the sealing position. Typically, this can be accomplished by providing an outer radius for gasket 312 that is at least about 2Ri. More specifically, in the instances where platform 304 is used to transport container 24, the outer radius of gasket target area 310 should be at least Rm−Rw; where Rm is the radius of the outermost mating sealing surface used, for example the radius of the outer edge 336 of rim 178 of container 24, and Rw again is the outer radius of the wand as previously defined. In instances where a combined carrier 222 and container 224 are transported by platform 304, Rm is measured in regard to the outer most mating surface used in those instances. This for example, could be a radius measured at a point on container rim 264, or on carrier rim 268, or some other outermost point used as the transported mating surface to be sealingly engaged with gasket 312.

It is noted that modifications could be made to accomplish the desired sealing of interior 38 of container 24 for the steam injection heating of its contents. For example in regard to apparatus 10, it is noted that a gasket (not shown) may be secured to top surface 172 of container rim 178. In such case, gasket 182 could optionally be eliminated. When container 24 having such a modification is raised to the sealing position, the added gasket on rim 178 could directly contact and seal at lower surface 188 of plate 70, to thereby seal container interior 38.

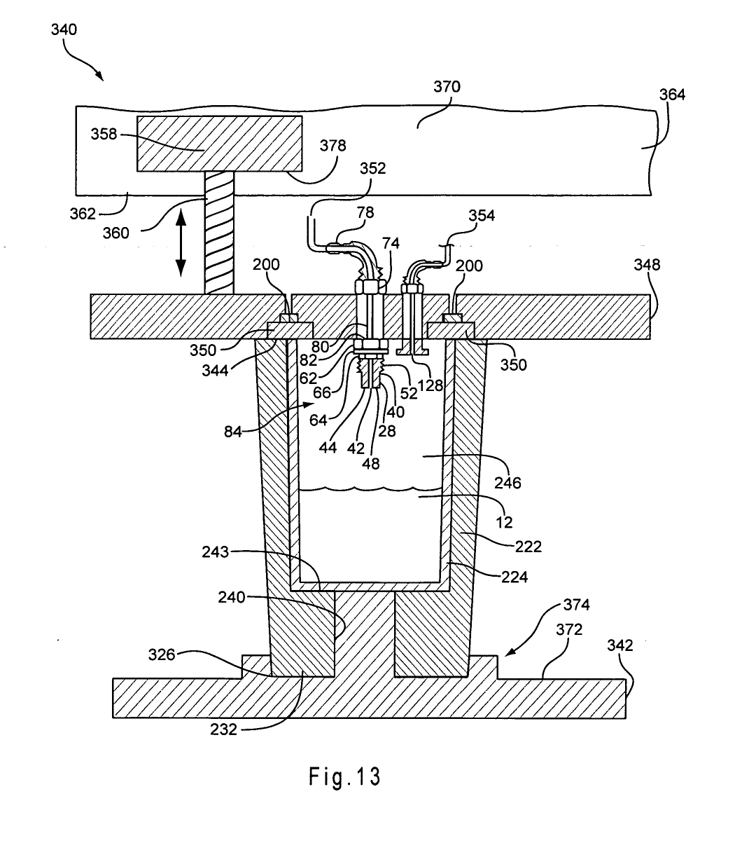

Still other modifications of the present invention are possible. For example, a steam injection heating apparatus such as apparatus 220 could be modified to accomplish sealing of a container interior by transporting the sealing surface to a stationary container 24, or in other instances a combined carrier 222 and container 224. Thus, in accordance with a third embodiment of the present invention, exemplary apparatus 340 has a platform 342 that is stationary, and a sealing surface 344 on a plate 348 that is reciprocally movably towards platform 342. Sealing surface 344 preferably includes a gasket 350 that is mounted on and carried by plate 348. Plate 348 also carries and transports mounted wand 28 and outlet vent 128. A flexible tube 352 connects wand 28 to a supply of steam from flash steamer 30. Flexible tube 354 is connected to outlet vent 128 for the venting purposes previously described. Force sensors 200 may also be mounted to plate 348 to serve the same function as also previously described. A motor 358 is connected to plate 348 by shaft 360. Motor 358 is operated to cause plate 348 to move between a loading position (not shown) and a sealing position as is shown in FIG. 13. The loading position is provided by moving plate 348 upward away from the sealing position. For example, the loading position may be provided by moving plate 348 to a position that is proximate to the lower surface 362 of the upper portion 364 of apparatus housing 370. At the loading position, plate 348 is spaced away from platform 342 so as to provide adequate clearance for loading or unloading of carrier 222. More specifically, a clearance between wand 28 and carrier 222 supporting container 224 is provided to allow the convenient loading of carrier 222 onto stationary platform 342, and removal therefrom after heating.

The top surface 372 of platform 342 includes a carrier locator 374 for the alignment of carrier 222. After carrier 222 is positioned on platform 342 and aligned by locator 374, motor 358 is operated to transport plate 348 to the sealing position. This is accomplished, for example, by motor 358 extending shaft 360 downward away from motor housing 378 to move plate 348 downward to the sealing position shown in FIG. 13. At the sealing position, gasket 350 seals interior 246 of container 224. Thereafter, steam injection heating of food product 12 can take place in a manner similar to that previously described. After heating, motor 358 is operated to upwardly return plate 348 to the loading position to allow removal of carrier 222 and container 224. Control 104 preferably is programmed to automatically control the operation of motor 358 to cause the movement of plate 348 between the loading and the sealing positions. Control 104 may also be programmed to automatically control the other previously described processes of the steam injection heating cycle. It is also noted the principles of transporting plate 348 to a stationary platform 342 could also be readily adaptable to a platform 342 modified for supporting a container, such as container 24 that is not supported by a carrier 222.

While the invention has been described with respect to certain preferred embodiments, it is to be understood that the invention is capable of numerous changes, modifications and rearrangements without departing from the scope or spirit of the invention as defined in the claims.

What is claimed is:

1. An apparatus for heating food contained in the interior of a container comprising:
a steam generator for generating steam;
a steam exit port in fluid communication with the steam generator, the exit port for injecting steam therethrough and into the container;
a surface for permitting the container interior to be put into an at least substantially sealed condition in a substantially closed environment with the exit port in fluid communication with the interior of the container;
a container support for supporting the container and in combination with the sealing surface for causing the container to be placed into the at least substantially sealed position.

2. The apparatus as claimed in claim 1 further comprising:
a first relative position for the sealing surface and the container support whereat the container can be positioned on the support;
a second relative position of the sealing surface and the container support whereat the support in combination with the sealing surface causes the container to be placed into the at least substantially sealed position for the injection of steam into the container; and
a motor for causing movement between the first relative position and the second relative position of the sealing surface and the container support.

3. The apparatus as claimed in claim 2 further comprising the support having a locator for aligning the container with the exit port, and the locator provides an alignment with the sealing surface to allow the container interior to be placed in the at least substantially sealed position when the apparatus is in the second relative position.

4. The apparatus as claimed in claim 2 further comprising:
a sensor for sensing if the container is in the at least substantially sealed position; and
a control for initiating steam injection into the container, the control initiating the steam injection if the sensor senses that the container interior is in at least substantially sealed position, and during steam injection the control terminating steam injection if the sensor senses the container interior is no longer in the at least substantially sealed position.

5. The apparatus as claimed in claim 4 further comprising:
a pressure sensor for sensing the pressure in the interior of the container; and
the control preventing the motor from causing the movement from the second relative position when the pressure in the interior of the container is above a pre-selected pressure.

6. The apparatus as claimed in claim 2 wherein the motor applies a force to maintain the container interior in the at least substantially sealed position during the injection of steam into the interior of the container.

7. The apparatus as claimed in claim 2 further comprising a gasket mounted to the apparatus and the gasket provides the sealing surface.

8. The apparatus as claimed in claim 1 further comprising:
a carrier for removeably holding the container and for supporting the container during the injection of steam into the container.

9. The apparatus as claimed in claim 8 further comprising:
the carrier includes an opening for receiving the container, and the container is a flexible, disposable container.

10. The apparatus as claimed in claim 9 further comprising:
the carrier having a container access opening for providing access for separating the container from the carrier.

11. The apparatus as claimed in claim 10 wherein the carrier has a carrier surface that contacts the sealing surface to at least substantially seal the interior of the container.

12. The apparatus as claimed in claim 8 further comprising:
a wand that includes the steam exit port;
a locator on the support for aligning the carrier on the support, the alignment preventing contact of the wand when the apparatus is moved from the first relative position to the second relative position, and the alignment by the locator permitting the sealing surface to be contacted to substantially seal the container interior when the apparatus is moved from the first relative position to the second relative position.

13. The apparatus as claimed in claim 2 further comprising:
a wand that includes the exit port;
a mating surface for mating with the sealing surface to substantially seal the interior of the container, the mating surface spaced from the sealing surface when the apparatus is in the first relative position, and the mating surface contacts the sealing surface when the apparatus is in the second relative position; and
a locator on the support for aligning the mating surface with the sealing surface so that the mating surface contacts the sealing surface when the apparatus is in the second relative position.

14. The apparatus as claimed in claim 13 further comprising
the sealing surface having a target area;
the wand having an outer radius of Wr;
the container having an opening and a rim adjacent the opening with the rim having an inner radius of Ri, and the container having a bottom with an outer bottom radius of Rb;
the locator having a placement area with an outer border having a radius of Rp; and
the placement area Rp being selected from a range having a lower end of about approximately 10% larger than Rb and a high end of slightly less than Ri−Rw+Rb, so that when the bottom of the container is entirely positioned within the border of the placement area and the apparatus is moved from the first relative position to the second relative position, the wand enters the opening and is not contacted by the container, and the mating surface contacts the target area of the sealing surface to cause the container to be placed in the substantially sealed position.

15. The apparatus as claimed in claim 13 further comprising:
the sealing surface having a target area;
the wand having an outer radius of Wr;
the container having a top opening and a rim adjacent the opening with the rim having an inner radius of Ri;
a carrier for receiving and supporting the container, the carrier having a top opening and a bottom having an outer radius Rc;
the locator having a placement area with an outer border having a radius of Rp; and
the placement area Rp being selected from a range having a low end of about approximately 10% larger than Rc and a high end of slightly less than Ri−Rw+Rc, so that when the bottom of the carrier is entirely positioned within the border of the placement area and the apparatus is moved from the first relative position to the second relative position, the wand enters the opening of the rim and is not contacted by the container, and the mating surface contacts the target area of the sealing surface to cause the container to be placed in the substantially sealed position.

16. A method of heating food contained in the interior of a container comprising:
providing a steam generator for generating steam;
providing an exit port in fluid communication with the steam generator for injecting steam therethrough into the container;
providing a sealing surface for permitting the container interior to be put in an at least substantially sealed condition in a substantially closed environment with the exit port in fluid communication with the interior of the container;
providing a support for supporting the container;
supporting the container on the support;
causing relative movement between the support and the sealing surface to cause the container interior to be placed in an at least substantially sealed position with the exit port in fluid communication with the interior of the container; and
thereafter injecting steam into the interior of the container to heat the food in the container.

17. The method as claimed in claim 16 further comprising;
providing a first relative position between the support and the sealing surface whereat the support and the sealing surface are sufficiently spaced apart for loading the container on the support;
providing a second relative position between the support and the sealing surface whereat the sealing surface is contacted to cause the container interior to be at least substantially sealed;
automatically moving the apparatus to the first relative position; thereafter
loading the container onto the support; thereafter
automatically moving the apparatus to the second relative position to at least substantially seal the interior of the container; thereafter;
injecting steam into the interior of the container to heat the food; thereafter
automatically moving the apparatus to the first relative position; and thereafter
removing the container with heated food from the support.

18. The method as claimed in claim 17 further comprising applying a force to maintain the interior of the container in the sealed position during the injecting of steam into the food.

19. The method as claimed in claim 17 further comprising;
sensing if the container interior is sealed before permitting the injection of steam into the container interior.

20. The method as claimed in claim 19 further comprising;
sensing the pressure in the interior of the container before allowing movement away from the second relative position;
preventing movement away from the second relative position if the pressure of the interior of the container is sensed to be more than a determined pressure.

21. The method as claimed in claim 16 further comprising:
providing a carrier for holding the container and supporting the container during steam injection heating;
placing the container in the carrier; and
supporting the container in the carrier during the steam injection heating of the food.
